(19) United States
(12) Patent Application Publication
(10) Pub. No.: US 2018/0121420 A1
(43) Pub. Date: May 3, 2018

(54) RESULT SET MANIPULATION

(71) Applicant: Actiance, Inc., Redwood City, CA (US)

(72) Inventor: John ONUSKO, Garden Valley, CA (US)

(73) Assignee: Actiance, Inc., Redwood City, CA (US)

(21) Appl. No.: 15/799,880

(22) Filed: Oct. 31, 2017

Related U.S. Application Data
(60) Provisional application No. 62/415,378, filed on Oct. 31, 2016.

(51) Int. Cl. G06F 17/27; G06F 17/30; G06Q 10/10

(52) U.S. Cl. CPC G06F 17/2785; G06F 17/30554; G06Q 10/107; G06F 17/30722; G06F 17/278; G06F 17/30604

(57) ABSTRACT

A unified context-aware content archive system allows enterprises to manage, enforce, monitor, moderate, and review business records associated with a variety of communication modalities. The system may store interactions between participants allowing for derivation or inference of communication events, chronologies, and mappings. In one aspect, information retrieval can involve dynamic manipulation of result sets based on hierarchical relationships between stored communication interactions.

### CROSS-REFERENCES TO RELATED APPLICATIONS

This application claims the benefit of U.S. Provisional Patent Application No. 62/415,378, filed on Oct. 31, 2016, the content of which is herein incorporated by reference in its entirety for all purposes.

### BACKGROUND

Embodiments of the present invention generally relate to techniques for more efficient processing of electronically stored information (ESI). More particularly, the present inventions relates to techniques for processing search result sets that are typically too large to be stored in the memory of a user's individual workstation.

Collaboration using a variety of communication modalities, such as e-mail, instant messaging, voice over Internet Protocol (VoIP), and social networks is becoming increasingly ubiquitous. Many users and organizations have transitioned to paperless or all-digital offices, where information and documents are communicated and stored almost exclusively digitally. As a result, users and organizations are also now expended time and money to store and archive increasing volumes of digital documents and communication metadata.

At the same time, state and federal regulators, such as the Securities and Exchange Commission (SEC), have become increasingly aggressive in enforcing regulations that mandate the archival and review of communications made using these communication media. Such reviews can be complex when participants engage in a conversation that spans multiple communication modalities, such as transitioning from email to instant messaging to social media, etc. Additionally, criminal cases and civil litigation frequently employ use of electronic discovery (eDiscovery) tools, in addition to traditional discovery methods, to locate, secure, and search with the intent of using communications as evidence.

Clearly, problems with the increasing volumes of digital documents and communication metadata that accumulates is how the data is captured, archived, and later retrieved for review. Voice/video conferences are routinely held. Emails frequently include multiple participants and one or more multi-megabyte attachments. Instant messaging sessions can also be used to transfer files and pictures. Use of social networking applications have grown exponentially. As users grow accustomed to communicating using a variety of communication modalities, the data associated with each different communication medium becomes increasingly diverse. As developers compete for users of their applications, propriety formats are often used which makes later access to the captured data difficult without the required software.

Another problem that is faced by organization-based or regulatory-based disclosure and/or reporting requirements is that most are simply not required to preserve the information for subsequent disclosure. Often, the disclosure and/or reporting requirements are directed toward the context of a communication, the role of a participant in the communication, the level of access a participant had to sensitive data referred to in the communication, or the like.

Accordingly, what is desired is to solve problems relating to storing electronic communications using multiple different communication and to reduce drawbacks relating to searching a continually evolving document corpus.

### BRIEF SUMMARY

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be to present some innovations, embodiments, and/or examples found within this disclosure in a simplified form as a prelude to a more detailed description presented later.

In certain embodiments, a computer-implemented method may include receiving a query including one or more search criteria for searching a document corpus and projection data indicating how to organize a corresponding resulting search, and determining a set of documents stored in one or more document archives of the document corpus that includes data corresponding to the one or more search criteria. The query can be received at one or more computing systems and the determining may be performed by one or more processors associated with the one or more computer systems. The method can further include staging each document in the set of documents in a result set, staging metadata associated with one or more documents in the set of documents in the result set, determining a set of relationships between the one or more documents using the metadata and the projection data, and organizing the result set into a visualization using the determined set of relationships. In some cases, the result set can be distributed across a plurality of memory devices associated with the one or more computer systems, and the method may further include staging content retrieved from the one or more document archives for the one or more documents using a distributed cache.

The method may include augmenting content in the result set using information retrieved from one or more data sources external to the document archive based on the metadata. Additionally, the method can include receiving, at the one or more computer systems, a policy, and managing, with the one or more processors associated with the one or more computer systems, a lifecycle of the result set in the plurality of memory devices associated with the one or more computer systems using the policy.

In some embodiments, determining the set of relationships between the one or more documents using the metadata may include generating relationships between the one or more documents using a sender identifier or one or more recipient identifiers, a subject or a topic, and/or a communication modality. In some cases, the determining the set of relationships between the one or more documents using the metadata can include filtering out documents from the set of documents that have no relationship to the one or more documents.

In certain embodiments, the organizing, with the one or more processors associated with the one or more computer systems, the result set into a visualization using the determined set of relationship may include sorting documents in the result set using a sender identifier or a recipient identifier, a subject, a topic, or a communication modality.

Some embodiments may include a non-transitory computer-readable medium storing program code executable by a processor of a computer system, the non-transitory computer-readable medium comprising program code that causes the processor to receive a query including one or more search criteria and projection data indicating how to organize a corresponding resulting search; program code that causes the processor to determine a set of documents stored in one or more document archives of the document corpus that includes data corresponding to the one or more search criteria; program code that causes the processor to stage each document in the set of documents in a result set; program code that causes the processor to stage metadata associated with one or more documents in the set of documents in the result set; program code that causes the processor to determine a set of relationships between the one or more documents using the metadata and the projection data; and program code that causes the processor to organize the result set into a visualization using the determined set of relationships.

In some cases, the result set determined by the program code can be distributed across a plurality of memory devices associated with the one or more computer systems, and program code may further be configured to cause the processor to stage content retrieved from the one or more document archives for the one or more documents using a distributed cache, and/or to augment content in the result set using information retrieved from one or more data sources external to the document archive based on the metadata. The non-transitory computer-readable medium may further include program code that causes the processor to receive a policy and manage lifecycle of the result set in the plurality of memory devices associated with the one or more computer systems using the policy.

In further embodiments, the program code that causes the processor to determine the set of relationships between the one or more documents using the metadata may include program code that causes the processor to generate relationships between the one or more documents using a sender identifier or one or more recipient identifiers, using a subject or a topic, and/or a communication modality. In some cases, the program code that causes the processor to determine the set of relationships between the one or more documents using the metadata may include program code that causes the processor to filter out documents from the set of documents that have no relationship to the one or more documents.

In certain embodiments, the program code that causes the processor to organize the result set into a visualization using the determined set of relationship may include program code that causes the processor to sort documents in the result set using a sender identifier or a recipient identifier, and/or organize documents in the result set using a subject, a topic, or a communication modality.

A further understanding of the nature of and equivalents to the subject matter of this disclosure (as well as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 is a block diagram of an electronically stored information system, according to certain embodiments of the present invention.

FIG. 2 is a block diagram illustrating different applications of the electronically stored information system of FIG. 1, according to various embodiment of the present invention.

FIG. 3 is a simplified flowchart of a method for archiving content in a context-aware manner, according to certain embodiments of the present invention.

FIG. 4 is a block diagram illustrating an overview of a flow in terms of data and process in electronically stored information system of FIG. 1, according to certain embodiments of the present invention.

FIG. 5 is a diagram illustrating an overview of capture point data flow, according to certain embodiments of the present invention.

FIG. 6 illustrates an archival pipeline for snapshot construction, according to certain embodiments of the present invention.

FIG. 7 is a block diagram of a system for managing result sets, according to certain embodiments of the present invention.

FIG. 8 is a flowchart of a method for building result sets, according to certain embodiments of the present invention.

FIG. 9 is a flowchart of a method for building result sets, according to certain embodiments of the present invention.

FIG. 10 is a flowchart of a method for building result sets, according to certain embodiments of the present invention.

FIG. 11 is a flowchart of a method for generating one or more visualizations using result sets, according to certain embodiments of the present invention.

FIG. 12 is a flowchart of a method for generating one or more visualizations using result sets, according to certain embodiments of the present invention.

FIG. 13 is a flowchart of a method for staging search results from a document corpus, according to certain embodiments of the present invention.

FIG. 14 is a block diagram of a computer system that may be used for archiving electronically stored information, according to certain embodiments of the present invention.

### DETAILED DESCRIPTION

In various embodiments, a unified context-aware content archive system provides an information storage and retrieval framework that allows enterprises to manage, enforce, monitor, moderate, and review business records associated with a variety of communication modalities.

### Terminology

To assist in the understanding of this disclosure, the following provides general definitions of a number of terms and phrases used herein with a view toward aiding in the comprehension of such terms and phrases. As space limitations can preclude a full delineation of all meanings, the general definitions that follow should be regarded as providing one or more intended meanings of the terms and phrases. Unless otherwise specified, the general definition should not be viewed as being an exhaustive list or otherwise excluding the ordinary plain meanings of the terms or phrases.

A unified context-aware content archive system, according to some embodiments, may store interaction transcripts that include a set of information derived or inferred from one or more documents representing one or more communications captured using the variety of communication modalities. An interaction transcript has used herein describes one or more interactions between a set of one or more participants to one or more communications using a set of one or more documents. The interaction transcript can include information about the documents themselves. The interaction transcript can also describe a set of communication events that occurred with the set of documents, chronologies, mappings, and the like. The interaction transcript can be stored in a common data structure that normalizes all the different communication modalities.

In one aspect, the interaction transcript can describe one or more event correlations between a set of participants of a set of communications using general time series analysis for the purposes of extracting meaningful statistics, interaction contexts, and other characteristics of documents. In another aspect, the interaction transcript can describe one or more chronological mappings of a set of conversations between an established start and end time. In yet another embodiment, the interaction transcript can describe one or more mappings between a set of interactions, conversations, threads, posts made without timestamps, or the like. In some aspects, the interaction transcript can describe one or more correlations using multivariate modalities that allow for expressiveness of chronological mappings of inter and intra events.

Furthermore, the unified context-aware content archive system allows for the time series analysis and processing on context-aware data stored by the archive system. In some embodiments, the archive system constructs a timeline-based conversation view from input provided from any data source represented as a normalized communication transcript. As used herein, a conversation view is a graphical presentation executed by an external program to provide further insights in the discovery process with details about the event, correlation, relationship, or mapped context of the content using specialized parameters. Conversation views are derived from snapshot construction.

Interaction—An interaction generally refers to an unbounded or bounded sequence or series of communication events according to one or more of a plurality of communication modalities. An interaction may include one or more participants participating during each communication event.

Interaction Transcription Model (ITM)—An ITM models the transcript of one or more interactions described by electronic data delivered over one or more of a plurality of communication modalities. In some embodiments, a capture point is configured to produce an ITM object and then submit the ITM to a universal context-aware data storage system, such as the unified context-aware content archive system referred to herein.

Communication Modality—A communication modality generally refers to a communication classification reflecting base characteristics of one or more channels and/or networks as a means to collaborate between one or more participants over one or more chosen communication mediums. Some examples of communication modalities for purposes of this disclosure include electronic mail (email), instant messaging/chat, web collaboration, video conferencing, voice telephony, social networks, and the like. For purposes of this disclosure, four super classes of communication modalities are explained to generalize most communication forms. These super classes include: Email, Unified Communications, Collaboration, and Social Networks.

Email—An email communication modality generally refers to a class of communication media or a medium that models non-realtime electronic communication. One example of a non-realtime electronic communication is electronic mail (email or e-mail). Email is typically a ubiquitous form of communication between one or more participants (e.g., a sender and one or more recipients). As used herein, an electronic communication may include one or more documents (e.g., emails represented in one or more of a plurality of forms) that serve as a basis for one or more business records.

Unified Communication—A unified communication modality generally refers to a class of communication media or a medium that models real-time or substantially real-time communication. Some examples of unified communications includes instant messaging, voice (analog and digital), VoIP, etc. Unified communication is also typically a ubiquitous form of communication between one or more participants and, as used herein, may include one or more documents (e.g., IM/Chat sessions, voicemail, etc. represented in one or more of a plurality of forms) that serve as a basis for one or more business records.

Collaboration—A collaboration communication modality generally refers to multiple classes of communication media that encapsulate a plurality of communication modalities. A collaboration is typically represented as a unique or unified thread of communication. A collaboration can therefore be referred to as a multi-variant modality. In one example of a communication, Alice starts a WebEx session related to corporate information with Bob. Bob engages in an instant messaging (IM) session with Charlie who is a subject matter expert on the corporate information and who also is not an employee of the company that employs Alice and Bob. Bob then sends an email to one or more participants external to the company to further discuss the corporate information and the IM session with Charlie. This collaboration example contains at least three communication modalities starting with the WebEx session, the IM session, and Bob's email. A collaboration communication modality may be represented in one or more of a plurality of forms that serve as a basis for one or more business records.

Social Network—A social network communication modality generally refers to one or more interactions among specialized social networks or communities. In general, modern day social networking software platforms are designed to engage, promote or foster social interactions among communities such as family members, peers, specialized social networks/communities, and enterprise collaborators. Examples of social networks include Facebook, Twitter, Linked-In, etc. A social network communication modality may be represented in one or more of a plurality of forms that serve as a basis for one or more business records.

A content-agnostic storage system as used herein generally represents hardware and/or software elements configured for storing entities representing a definition of an interaction between one or more participants according to a variety of communication modalities. The system may perform the managing, integrating, and searching of data associated with the storage and retrieval of models of various interactions. Some examples of storage resources include data storage independent solutions using RDBMS, XML Repositories, File Systems, and Key-Value storage; aka Big Data storage.

A context-aware search engine as used herein generally represents hardware and/or software elements configured for indexing and searching data associated with the storage and retrieval of models of various interactions. Some examples include Web Scale Full-Text Search distributed server farms and Tuple-based Search using Relations. This may include a convergence of RDBMS and Big Data Search for context-aware indexing and searches.

A data capture system as used herein generally represents hardware and/or software elements configured for capturing content associated with one or more communication modalities. Content may be captured as wired (transport datagram) and application data. In various embodiments, content may be captured as documents formatted according to known protocols or standards for messages of particular communication modalities. Content may be processed to derive interaction transcripts for storage into a content-agnostic storage system for the purposes of compliance enforcement, moderation, and review as discussed further herein.

A data capture system may capture content using a variety of mechanisms. In one example, data at rest as used herein generally refers to one or more means for processing and/or enriching data that is classified as being resident in a storage or repository system. Typically, the data is to be read into a volatile state (memory), processed (enriched, mutated, analyzed, etc.), and then placed back into storage, such as persistent storage. Data in motion as used herein generally refers to one or more means for capturing, extracting, enriching, tracking, or otherwise processing data classified as participating in real-time events. Typically, the data is transient and thus held in volatile state even if it is traversing a wire or wireless transport.

Big Data as used herein generally refers to any technology that makes use of key-value storage. Big Data typically includes computation as a basis of a distributed file system or a collection of server farms using commodity hardware and storage. Big Data can be used for: Scaling Storage (infinite storage), Scaling Computing/Processing Power, or Both. Big Data can also be used for: Public Cloud, Private Cloud, Private Data Center, On-Premise, or Hybrid Cloud/Data Center.

Multi-Variant Index—A multi-variant index as used herein generally refers to the application of cross-indexes used as an aggregated form to derive a single and normalized searchable content from the viewpoint of the application. This requires use of multi-variables (dimensions) to generate the composite index that may be virtualized across segments (shards) on distributed nodes or server farms. A single index usually comes in the form of a reverse index, which is a means to compute document addresses (locations) in a single file. This allows for O[c] constant lookup of documents.

Conversation Timeline—A conversation timeline as used herein generally refers to a visualization artifact represented by a user interface application that displays a series of transcript events bounded by a time frame and connected by a correlation of the conversation in context. The correlation can be mapped by global communication ID, subject or topic of the conversation. Additional mappings can be based on a hierarchy of relationships indicating sub contexts, events or conversations. The ITM allows for any visual re-construction via intelligent visual analytics tools.

Conversation Document—A conversation document as used herein generally refers to a normalized document structure that encapsulation interaction metadata, text events (body of an email, content of a user blog, text message of an IM program), file events (the binary representation of an email attachment, video file, audio recording, etc.), and information about the participants (person info).

Snapshot—A snapshot as used herein generally refers to a logical storage structure representing a reconstruction of a communication object (Wiki, blog post, forum post, etc.) to any point in time using the time-based events that occurred on that object. All actions (create, update and delete) are replayed so that the communication object is accurately represented at a desired point in time.

“Live” document Processing—Such processing as used herein generally refers to the process of applying a “most significant snapshot” in the context aware content storage. “Live” is a euphemism for system and process adaption by the data processing engine due to asynchronous and real-time events in response to an incoming transcript, context or execution-route request.

Living document—A living document as used herein generally refers to a document or set of documents that take on a dynamic nature. Primarily the assumption is that the document or set of documents are subject to constant changes in that there are one or more mechanisms at work that are continuously updating, editing, and stamping the documents or versions related thereto with a new data revision. A Blogging application or internal content management system are examples of applications that generate living documents. As discussed further below, the materialized artifact of a living document, so called snapshots, are constructed to represent one or more timelines based on communication transcripts captured by capture endpoints and correlated by event metadata from which one or more instances of a living document may be recreated. A living document may include “dead, static” and “living” elements or communication objects.

Event-metadata—Event-metadata as used herein generally refers to Key Meta-information signifying one or more of the following attributes (note there may be more):
Global communication ID
An action event time stamp (e.g., create, updated, started, edited, deleted, modified etc. time signature corresponding to precisely when the action occurred).
Information about the individual, we refer to this as the participant or a person responsible for the event action. For example, someone who created and submitted an email, added a blog entry to a form, created an electronic document and uploaded to a SharePoint repository, authorship of a telephony or video recording.

### Electronically Stored Information System

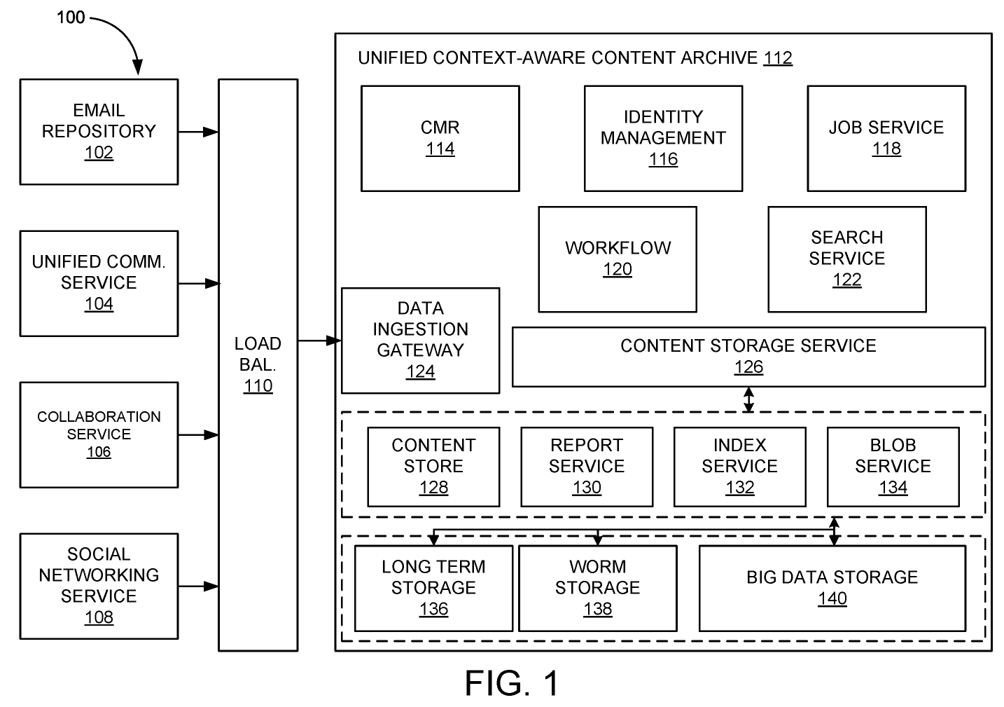

FIG. 1 is a block diagram of electronically stored information (ESI) system 100 according to certain embodiments of the present invention. ESI system 100 may incorporate various embodiments or implementations of the one or more inventions presented within this disclosure. In this example, ESI system 100 includes email repository 102, unified communications service 104, social networking service 108, load balancer 110, and unified context-aware content archive 112. FIG. 1 is merely illustrative of an embodiment or implementation of an invention disclosed herein should not limit the scope of any invention as recited in the claims. One of ordinary skill in the art may recognize through this disclosure and the teachings presented herein that other variations, modifications, and/or alternatives to those embodiments or implementations illustrated in the figures.

Email repository 102 is representative of one or more hardware and/or software elements from which information related to an email communication modality may be obtained.

Email repository 102 may provide access to one or more email documents and associated metadata. An email document can include a header portion and a message portion. The header portion can include a set of lines containing information about the message's transportation, such as the sender's address, the recipient's address, or timestamps showing when the message was sent by intermediary servers to the transport agents (MTAs), which act as a mail sorting office. The message portion can include a body portion and one or more attachments.

Email repository 102 may act as an email storage service, an email transport service, an email gateway, or the like. One example of the email repository 102 is a computer system running Microsoft Exchange Server from Microsoft Corporation of Redmond, Wash. In other examples, email repository 102 may include operating systems, such as Microsoft Windows™, UNIX™, and Linux™, and one or more mail transport agents, mail user agents, and the like. Email communications may be stored on email repository 102 or accessibly therefrom in a file, such as an Outlook PST file or MBOX file, in a database, or the like.

Unified communications service 104 is representative of one or more hardware and/or software elements from which information related to a unified communication modality may be obtained. Unified communications service 104 may provide access to one or more unified communication documents and associated metadata. Unified communications service 104 may provide access to real-time communication services such as instant messaging (chat), presence information, telephony (including IP telephony), video conferencing, data sharing (including web connected electronic whiteboards aka IWB's or Interactive White Boards), call control and speech recognition. Unified communications may be stored on unified communications service 104 or accessibly therefrom in a file, in a database, or the like.

Collaboration service 106 is representative of one or more hardware and/or software elements from which information related to a collaboration communication modality may be obtained. Collaboration service 106 may provide access to one or more collaboration documents and associated metadata. Collaboration service 106 can include collaborative software or groupware products such as email, calendaring, text chat, wiki, and bookmarking used for group work in a collaborative working environment (CWE). Collaboration service 106 communications may be stored on collaboration service 106 or accessibly therefrom in a file, in a database, or the like.

Social networking service 108 is representative of one or more hardware and/or software elements from which information related to a social network communication modality may be obtained. Social networking service 108 may provide access to one or more social networking documents and associated metadata. In general, a social network can include a social structure made up of a set of social actors (such as individuals or organizations) and a complex set of the dyadic ties between these actors. Social networking service 108 may provide information about the social structure, the social actors, and the ties between the actors. Social networking service 108 may further provide information related to electronic communications made via one or more applications that host the social network.

In various embodiments, social networking service 108 provides monitoring in real-time and aggregating “social media” into a communication form that can be managed holistically using compliance protocols for the regulated industries. Accordingly, social media interactions may be collected for general storage and later search-ability. In one aspect, a social media interaction may include time points of communication events (e.g., an event transcript). Events may be determined corresponding to create, posts, updates, edit, modifications, deletion, etc., on artifacts associated with ESI systems. In another aspect, events may correspond to a blog, a chat, a video session, an audio recording, an instance message, a tweet, a newly constructed web page on a Portola site, a phone call, a television feed. These can be classified in real-time as predetermined events such as tweets, news alerts, Facebook posts, Linked-in events, etc.

In further embodiments, social networking service 108 provides a connection context. For example, social networking service 108 may determine participants involved in the communication that can be mapped to a logical social graph. Social networking service 108 may derive in-band and out-of-band context. In-band for purposes of this disclosure mean contexts within a social media platform, such as Salesforce, LinkedIn, Facebook, Twitter, MSN, Google+, etc. Social networking service 108 may use a native API to obtain metadata within a social network API. Out-of-band for purposes of this disclosure implies unrelated or disparate interconnects of social media networks (LinkedIn, Facebook, Twitter, etc.). To employ out-of-band information, social networking service 108 may employ normalization of metadata enrichment and aggregation of an information domain. Accordingly, a fuller context is provided of a participant's inter-connections and intra-connections to other participants across any social network domain. In other words, intra is more about in-band single social network domain and inter is about using plurality of 2 or more social network domains (e.g., the application of across and heterogeneous networks and/or social media platforms, such as Facebook, Tweeter, LinkedIn, Microsoft, Google, Apple, Bloomberg, etc.).

A social graph may be n-deep at the end of a termination chain (e.g., the last participant in a communication chain). Conversation can be bounded by system/application context. For example, an email participants' direct communication may be determined by the members on the “To:” list of an originating email. Each hop via traversing the participant's “To:” designator determines a “hop” or closed loop or ring of a graph. The scale of participants may be determined by the closed loop/ring or hops (i.e., the depth of the graph).

In various embodiments, out-of-band social connections may be derived by processing information based on sub-nets. This implication is that information is synthesized at the source of the capture point in the case where the information is already normalized by the capture point, for example, during passive processing. Data is at rest and waiting to be collected by upstream applications. Secondly, the total sum of information regarding inter-connection may be obtained by merging the aggregated sets into one normalized form. This may be done at two possible points of interests: a) the capture point (the point product or 3rd party application/connector) and within ESI system 100 at a normalization stage. ESI system 100 therefore captures “connections” within activities or interactions across different domains using real-time event streaming protocols or generalized capture points for data collection processing purposes.

Referring again to FIG. 1, load balancer 110 is representative of one or more hardware and/or software elements that distribute the workload of obtaining the different communication modalities from email repository 102, unified communications service 104, collaboration service 106, and social networking service 108. Load balancer 110 can distribute the workload across multiple computers or a computer cluster, network links, central processing units, disk drives, or other resources, to achieve optimal resource utilization, maximize throughput, minimize response time, and avoid overload.

Unified context-aware content archive 112 includes hardware and/or software elements configured to obtain information related to the multiple communication modalities and store interaction transcripts determined therefrom in a single information structure. In one example of operation, unified context-aware content archive 112 obtains electronic communications from email repository 102, unified communications service 104, collaboration service 106, and social networking service 108 via load balancer 110. Unified context-aware content archive 112 may obtain electronic communications using a variety of known techniques, such as push or pull mechanisms. In certain embodiments, unified context-aware content archive 112 may obtain electronic communications directly or indirectly through a service that monitors electronic communications in real-time or in non-real-time.

In various embodiments, unified context-aware content archive 112 is configured to receive electronic communications according to the above various communication modalities and processes documents representing the electronic communications to determine interactions between one or more participants. A series of events that form the interactions may be modeled as a single information structure facilitating storage and retrieval. Unified context-aware content archive 112 can store content in a searchable form via normalization into the single information structure that is retrievable based on contexts derived or inferred from the single information structure. Unified context-aware content archive 112 may incorporate a variety of traditional storage mechanisms (e.g., relational databases) and non-traditional storage mechanisms (e.g., Big Data).

In this example, unified context-aware content archive 112 includes content management repository (CMR) module 114, identity management module 116, job service module 118, workflow module 120, search service module 122, data ingestion gateway module 124, content storage service module 126, content store module 128, report service module 130, index service module 132, blob service 134, long term storage module 136, WORM storage module 138, and big data storage module 140.

Content management repository (CMR) module 114 represents hardware and/or software elements configured for managing an organization's content. CMR module 114 may incorporate technology to store and index, classify, search and retrieve objects of all types. CMR module 114 may be used by unified context-aware content archive 112 in the processing of or enrichment of electronic communications, management of data, and the like.

Identity management module 116 represents hardware and/or software elements configured for managing individual identifiers, their authentication, authorization, and privileges within or across system and organization boundaries. Identity management module 116 may be used by unified context-aware content archive 112 in the processing of or enrichment of electronic communications.

Job service module 118 represents hardware and/or software elements configured for managing one or more jobs or tasks. Job service module 118 may be used by unified context-aware content archive 112 in the processing of or enrichment of electronic communications.

Workflow module 120 represents hardware and/or software elements configured for managing or orchestrating one or more workflows. Workflow module 120 may be used by unified context-aware content archive 112 in the processing of or enrichment of electronic communications. A workflow may include one or more jobs or tasks. In one example, a workflow includes a communication capture step, an enrichment step that determines information related to the communication, a processing step that transforms or processing information related to the communication, a normalization step that generates a normalized version of the communication, and a storage step that stores the communication in one or more forms.

Search service module 122 represents hardware and/or software elements configured for managing searches related to communications. Search service module 122 may be used by unified context-aware content archive 112 in the indexing and retrieval of electronic communications.

Data ingestion gateway module 124 represents hardware and/or software elements configured for managing the ingestion of electronic communications from email repository 102, unified communications service 104, collaboration service 106, and social networking service 108 via load balancer 110. Data ingestion gateway module 124 may provide security features, access control lists, and the like for maintaining the integrity of and records for stored communications.

Content storage service module 126 represents hardware and/or software elements configured for managing the storage and retrieval of normalized electronic communications. Content storage service module 126 provides a content-agnostic storage system for storing, managing, searching, integration data storage independent solutions using RDBMS, XML Repositories, File Systems, and Key-Value storage; aka Big Data storage.

Content store module 128 represents hardware and/or software elements configured for managing the storage and retrieval of primarily textual information related to electronic communications. Report service module 130 represents hardware and/or software elements configured for managing the generation of reports related to captured, indexed and stored communications. Index service module 132 represents hardware and/or software elements configured for managing the indexing of stored communications. Some examples of indexes may be full-text indices, semantic analysis, topic indices, metadata indices, and the like. Blob service 134 represents hardware and/or software elements configured for managing the storage and retrieval of primarily binary data, such as attachments to emails and instant messages, voicemails, blogs, network posts, and the like.

Long term storage module 136 represents hardware and/or software elements configured for managing the long term storage and retrieval of electronic communications. WORM storage module 138 represents hardware and/or software elements configured for managing data in long-term storage. For example, WORM storage module 138 may be a data storage device in which information, once written, cannot be modified. This write protection affords the assurance that the data cannot be tampered with once it is written to the device. Big data storage module 140 represents hardware and/or software elements configured for managing data sets with sizes beyond the ability of commonly used software tools to capture, curate, manage, and process the data within a tolerable elapsed time.

In general, unified context-aware content archive 112 provides for the capturing of multiple forms of communication. Specifically, unified context-aware content archive 112 provides for domain specific classification of information established around email, unified communication, collaboration, and social networks. In one aspect, unified context-aware content archive 112 classifies electronic communication mediums into the four distinct aforementioned categories such that they share common characteristics. Some examples of common characteristics are event-base timing signatures (e.g., an event is sourced, injected or derived by corresponding point in time; i.e., time of incident), participants engaging in one or more connected interactions or conversations (e.g., unique correlations of persons can be made via CMR module 114 or identity management module 116 allowing identity mappings to be sourced, derived, or inferred—additionally, mappings may also be derived from social graphs by crawling social networks or connections), linked correlations through time series analysis, linked correlations through participant associations, aggregation/clustering or localization across group membership, and the like.

Unified context-aware content archive 112 further stores the common characteristics of the communication modalities via a normalization process into a single information structure. In various embodiments, unified context-aware content archive 112 generates an interaction transcript model (“ITM”) based on one or more electronic communications. The model is an entity that represents one or more interactions between one or more participants according to one or more communication modalities. As discussed above, unified context-aware content archive 112 is not merely archiving documents associated with electronic communications. Unified context-aware content archive 112 determines an interaction as a bounded definition of a series or sequence of events derived or inferred from a set of documents.

In one aspect, ITM provides a single point of normalization into unified context-aware content archive 112 for search-ability and expressiveness. The ITM can be tailored for eDiscovery pipelines and other applications. In one aspect, unified context-aware content archive 112 implements an extract-transform-load (ETL) process for electronic communications for data enrichment, deconstruction, information partition. Enrichment enables unified context-aware content archive 112 to reclassify information, inject and enrich metadata, and partition data across specialized medium store. Unified context-aware content archive 112 further allows for streamed and serialized content into underlying repository suitable for downstream indexable content and analytics.

In various embodiments, unified context-aware content archive 112 provides searchable content based on contexts derived or inferred via “Attribute Normalization” across disparate storage systems. Unified context-aware content archive 112 implements or otherwise creates an index that allows for conversation correlation between participants and derivations of relationships (e.g., participant to messages, participants to participants, message to participants). In one aspect, unified context-aware content archive 112 provides for searchable content based on time frames, derivation or inferred contexts via sequenced ordering of events corresponding to each distinct event, derivation or inferred contexts via chronologic events corresponding to each distinct event, and derivation or inferred contexts via linked to participants in question, derivation or inferred contexts via term association or referenced in messages or binary artifacts such as attachments, archive resources (e.g., tar, gzip, b2, etc.), derivation or inferred contexts via shallow and deep analytics requiring data and process mining techniques, and the like.

In various embodiments, unified context-aware content archive 112 determines one or more interaction contexts. Unified context-aware content archive 112 can capture, model, derive, synthesize, and visualize interactions through use of heuristics and algorithms using time-series and semantic analysis to capture, archive, and search for business records based on contexts of time-stamp, and person-based identity mapping. An interaction context helps derive or infer additional information, such as event signified by key attributes such as timestamp, a global unique identification, a sequence number, a modality of event signifying whether it is open or closed, information derived or inferred by a person's identity, derived or inferred social graphs based on communication connections between participants (i.e., linked interactions), and the like. An interaction context can further help derive or infer information such as expressiveness of an event correlating to the interaction by means of metadata injection for data in motion, data at rest, and metadata tagging, meta-meta models, metadata for identity mapping, metadata for messages, and data enrichment via flow injection techniques. Injection can happen at live traffic capture, proxy capture using non-governed devices, network events, transport flows, and application flows.

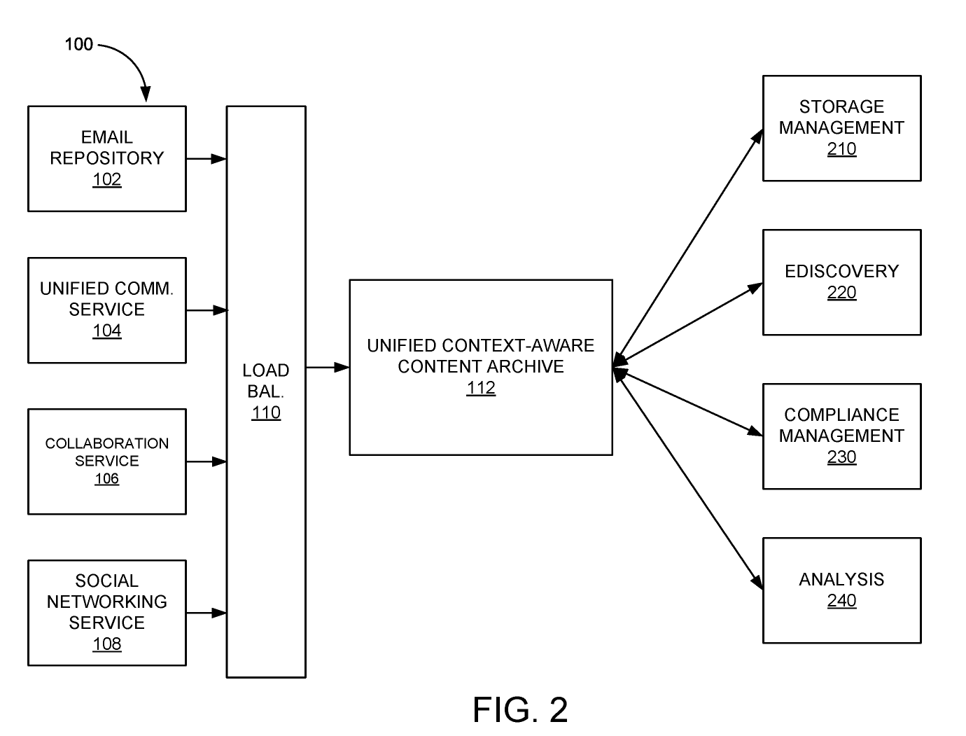

FIG. 2 is a block diagram illustrating different applications of ESI system of FIG. 100 according to various embodiment of the present invention. In this example, unified context-aware content archive 112 may be deployed in the cloud. Communication modality infosets and business record events may be sent to unified context-aware content archive 112 using a variety of protocols, such as HTTP/S Transport and SMTP Transport for Email Journal. The communication modality infosets undergoes a normalization process by unified context-aware content archive 112 to unify the infoset into a coherent structure that represents an interaction transcript model (“ITM”). As discussed above, unified context-aware content archive 112 may include one or more engines that allow for data enrichment, data partitioning and segregation into underlying storage medium, and data indexing whereby content index is generated based on data domain context.

In various embodiments, unified context-aware content archive 112 may be managed by storage management module 210. Storage management module 210 represents hardware and/or software elements configured to manage aspects of the operation of unified context-aware content archive 112.

In some embodiments, unified context-aware content archive 112 may be integrated with eDiscovery module 220, compliance management module 230, and analysis module 240. eDiscovery module 220 represents hardware and/or software elements configured for managing eDiscovery processes, such as an identification phase when potentially responsive documents are identified for further analysis and review, a preservation phase where data identified as potentially relevant is placed in a legal hold, a collection phase where once documents have been preserved, data can be transferred for processing (e.g., by legal counsel) to determine relevance and disposition, a processing phase where data is prepared to be loaded into a document review platform, a review phase where documents are reviewed for responsiveness to discovery requests and for privilege, and a production phase. In one aspect, eDiscovery module 220 may interface directly with the search capabilities and aggregated results provided by unified context-aware content archive 112.

Compliance management module 230 represents hardware and/or software elements configured for managing compliance requirements faced by an organization. In one aspect, compliance management module 230 may interface directly with the search capabilities and aggregated results provided by unified context-aware content archive 112. Analysis module 240 represents hardware and/or software elements configured for analyzing the stored information. A variety of analytics may be performed to determine information related to communications, modalities, participants, contexts, and the like.

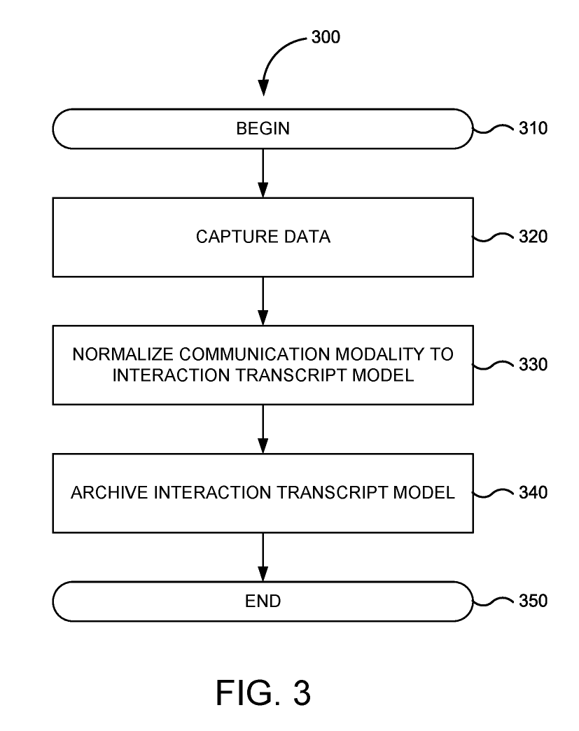

FIG. 3 is a simplified flowchart of method 300 for archiving content in a context-aware manner according to certain embodiments of the present invention. Implementations of or processing in method 300 depicted in FIG. 3 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 300 depicted in FIG. 3 begins in step 310.

In step 320, data is captured. As discussed above, multiple communication modalities can be captured from a variety of sources. In certain embodiments, documents representing communications can be extracted from a document repository (e.g., email repository 102, unified communications service 104, collaboration service 106, or social networking service 108). In certain embodiments, documents representing communications can be intercepted in real-time and delivered to unified context-aware content archive 112. In step 330, each communication modality is normalized to an interaction transcript model. Communication mediums can be classified into the four distinct aforementioned categories according to shared common characteristics. Infosets for multiple communication modalities are the normalized into the single information structure. In some embodiments, infosets may undergo processes for data enrichment, deconstruction, and information partitioning. In step 340, the interaction transcript model is then archived. FIG. 3 ends in step 350.

### Data Flow and Process

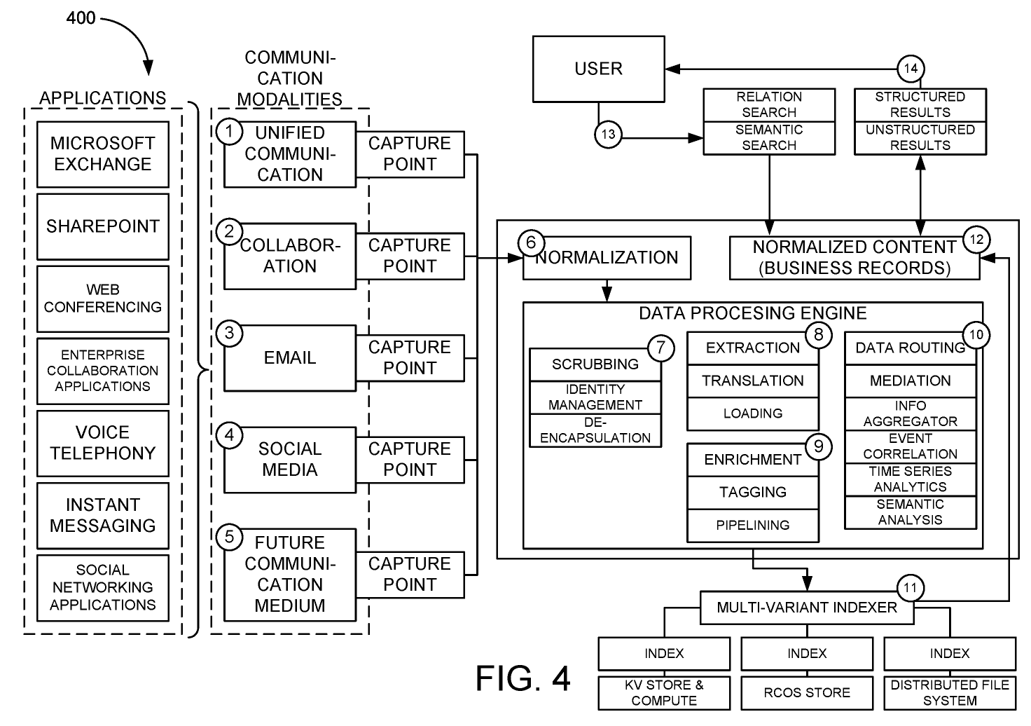

FIG. 4 is a block diagram illustrating an overview of a flow in terms of data and processes in ESI system 100 of FIG. 1 according to certain embodiments of the present invention. In this example, circles with a numeric value indicate a step of interest in the overview of the flow. In steps 1-5, communication modalities are captured from numerous applications/devices at a variety of generalized or specific capture points. Some examples of applications and devices from which communication modalities may be captured include, Microsoft Exchange/Outlook, Gmail, Hotmail, Lotus Notes, etc., SharePoint, IBM Connections, Web Conferencing such as WebEx, Skype, Microsoft Communication Server, Voice Telephony, Cisco Phones, Cell Phones, Mobile Phones, iOS, Android running on Mobile Devices, Tables, Slates, Instance Messaging, Microsoft Messenger, Salesforce Chatter, Jive, Social Media, Facebook, LinkedIn, Twitter. Each capture point, in essence, tracks the “dialogs” between humans and devices. A capture point may enrich the information to further provide the interaction context for downstream discovery (search, data/process/behavior/semantic mining, analytics, reporting, etc.)

In various embodiments, capture points of communication modalities can be information retrieval systems that allow a user to retrieve information having different attributes from heterogeneous application sources. In certain embodiments, a capture point is an agent that extends additional information for the purposes of deriving context. A searchable context then can be associated with the information based on enriched attributes of a subject represented by a user's interaction on a system with one or more humans by way of device communication.

In steps 6-10, the communication documents and context-oriented information is normalized into interaction transcripts and prepared for storage. In step 7, a data processing engine prepares each interaction transcript by performing scrubbing, identity management, and de-encapsulation. In step 8, the data processing engine prepares each interaction transcript by performing any data warehousing, such as extraction, translation, loading (ETL). In step 9, the data processing engine prepares each interaction transcript by performing enrichment, tagging, and pipelining. In step 10, the data processing engine prepares each interaction transcript by performing data routing, mediation, information aggregation, event correlation, time-series analysis, and semantic analysis.

In step 11, a multi-variant indexer cross-indexes each interaction transcript to derive searchable content. Multiple variables (dimensions) can be used to generate a composite index. Some examples of indexes can include a reverse index, full-text index, a key-value index, or the like. In step 12, normalized content is provided for storage. Data is not stored in traditional document form but rather virtualized into a coherent storage infrastructure that allows direct access and searchable content to data (document, binary, etc.), structure storage, and unstructured storage.

In steps 13-14, a user can interact with the normalized content using a variety of search methodologies, such as relation search or semantic search, and receive structured and/or unstructured data.

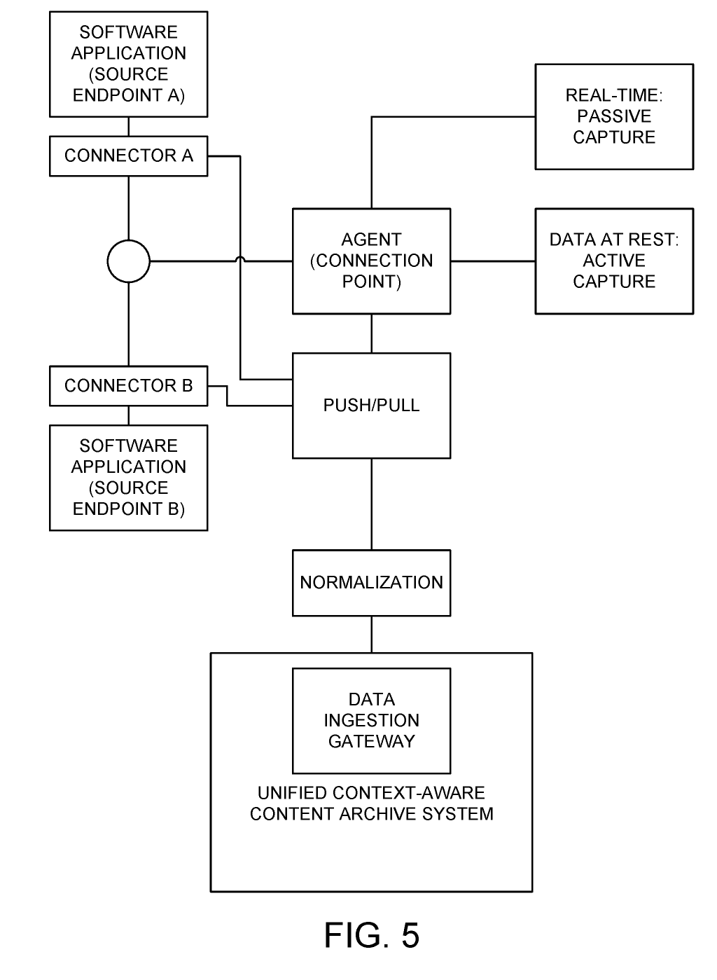

FIG. 5 is a diagram illustrating an overview of capture point data flow according to certain embodiments of the present invention. FIG. 5 provides for two methods used to enrich information derived from various communication modalities. In a first, entitled real-time (Data-in-Transit) passive capture, ESI system 100 provides for passive capture that denotes the ability to inspect packets (datagrams) over the wire without interference or requiring explicit data injection (enrichment) by participating devices (e.g., a device hosting software application—source endpoint A and a device hosting software application—source endpoint B). In a second, entitled (Data-at-Rest) active capture, ESI system 100 provides for active capture that denotes the ability engage participating devices. As device communication can include a broad-spectrum of target applications, running services, physical (stationary computer) or mobile devices residing on a network transport (the wire), as well as a variety of pathways to communicate to another endpoint, each method can be used independently or in combination.

In one aspect, ESI system 100 may utilize a wiretap to intercept communications. For example, a device can be used to collection information in real-time by sniffing data over the wire and collect the data at an agent (e.g., a capture/collection point). In another aspect, ESI system 100 may utilize connectors to intercept communications. For example, a connection associated with a device can be used to collection information in real-time and forward the data to the agent. In certain embodiments, the agent can utilize one or more external data repositories to correlate users or computers to traffic inspected by the wiretap or collected from the connectors. User credentials can be interrogated, validated, and ant the like by the agent. In some aspects, a user ID is mapped to an employer ID. In another aspect, a user ID is mapped to a buddy list (use of aliases or display names as account information supplied by user to connect to out-bound communication devices or software applications).

In the second, entitled (Data-at-Rest) active capture, ESI system 100 provides explicit intervention by software agents to enrich data along the pathway of communication between end points (users & device communications). Usually, this is done via an API or SPI complying with a well-defined protocol. In one aspect, ESI system 100 enriches data at the point of capture using the application sources (end points) used as a mean to facilitate and mediates the communication pathways between users. This is done typically be adding the connector to the source application which allows for direct insertion of metadata to a collection repository using a software development toolkit (“SDK”). Accordingly, one or more connectors are installed at application sources (end points). An API or SPI is made available from a software development toolkit is used to enrich the data and business records are stored in a collection repository via a binding protocol to submit normalized data.

All electronic information (media: text, document, voice, audio, messaging, etc.) are collected into a repository (unified context-aware content archive system). Once a document is resident (at rest), an enrichment process may take place on the captured electronic information as a business record. Some examples of enrichment are the determination and processing of event ids, transaction ids, correlation ids, links to connected events (prior/previous), participant ids, communication ids (information about the communication id), timeframe of conversation, information of all users involved in the originating communication, information of all file events (related file uploads, attachments, etc.), information of all text events (the primary context of the initiating communication; e.g., body of text, message, instant message, etc.), information derived from user session tracking, and the like.

Once data is enriched, an interaction context can be generated. The interaction context corresponds to an open-closed event that signifies the full scripts of text events, file events and corresponding participant events. This data is packaged and prepared for archiving.

Referring again to FIG. 5, a normalization process can occur for captured communication modalities prior to store in the archive. In one example, a business record is extracted from an agent's repository containing business records of interest. An infoset described by meta model (XML Schema) is pushed to a Data Ingestion Component. This normalized transcript under goes an ETL process for de-encapsulation of business records performed by the DPE staging pipeline. Information is then derived from the normalized transcript. An interaction context is generated whereby metadata about the events, start time, end-time, communication, event ID is determined. Furthermore, derived information may include a collection of participant events, a collection of text events, a collection of file events, or the like.

With the application of social media domains (large-scale networks; Facebook, LinkedIn, Twitter, Microsoft, Google, Applet, Bloomberg, etc.), the unified context-aware content store generates meaningful contexts of activities (interaction between participants, consumers, business entities, etc.) in real-time. In one aspect, meaningful contexts may be generated of (interaction between participants, consumers, business entities, etc.) at capture points—passive processing. In another aspect, search-ability of “normalized context” is improved by bridging all forms of communication into a single context (the conversation of interest for the business records).

In further embodiments, the unified context-aware content store provides an efficient application of storage. Data is not stored in traditional document form but rather virtualized into a coherent storage infrastructure that allows direct access and searchable content to data (document, binary, etc.), structure storage, and unstructured storage.

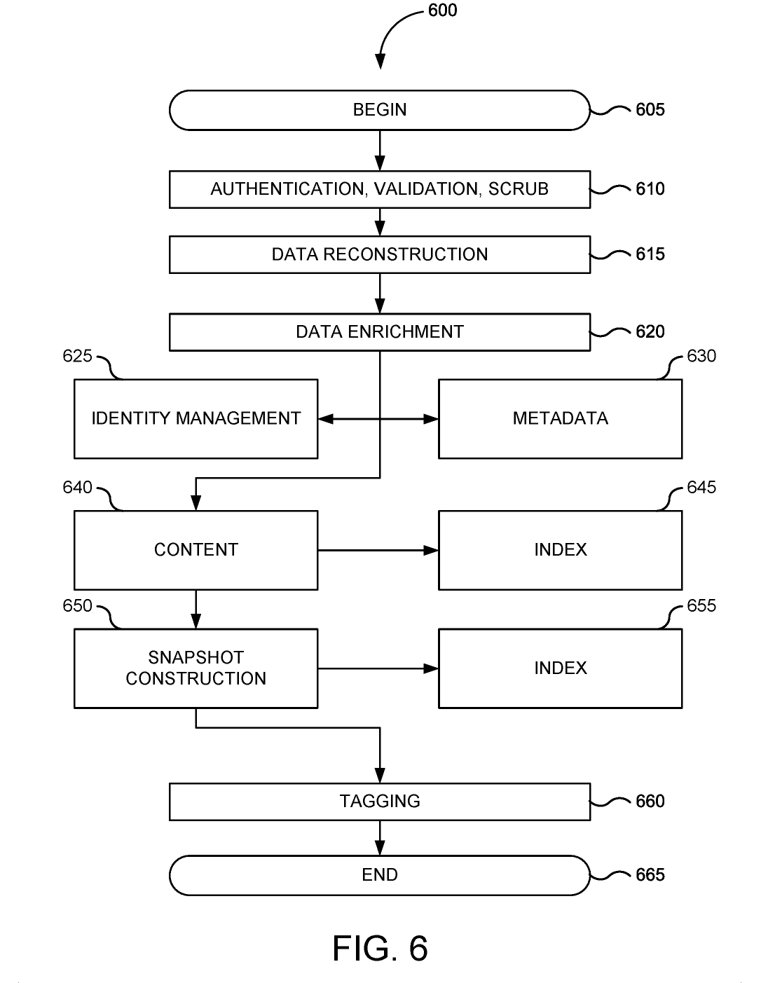

FIG. 6 illustrates archival pipeline 600 for processing captured data in certain embodiments according to the present invention. Implementations of or processing in archival pipeline 600 depicted in FIG. 6 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Archival pipeline 600 depicted in FIG. 6 begins in step 605.

In this example, a capture point may be installed at a customer's site (also referred to as a source collection point). The capture point captures communication data to be submitted to unified context-aware content archive 112. Each document sent to unified context-aware content archive 112 is stored in a form of a normalized transcript document (e.g., ITM).

In step 610, each document is authenticated, validated, scrubbed for key characteristics. This information can be used to augment any later enrichment processes. In one aspect, a document is authenticated and validated to determine proof of the documents. For example, metadata may be included that was given by a credible entity who has evidence of or can be relied upon for the document's identity. Additionally, evidence may be provided by the originator of the document. In another example, attributes of a document may be compared to what is known about other documents from the same source. As attribute comparison may be vulnerable to forgery, therefore one or more techniques such as digital certificates and encryption may be used to cause any forgeries to be readily distinguishable from a genuine document. In another aspect, authentication may rely on documentation or other external affirmations, such as establishing a chain of custody or the like. In other aspects, a document may be validated for the purposes of structure or content. In further aspects, a document may be scrubbed to complement missing data or sanitized to remove miscellaneous, irrelevant, confidential, or privileged information. In some embodiments, step 610 further includes storing a copy of original data for compliance purposes.

In step 615, each document is deconstructed. For example, a document may be divided into one or more segregated data domains. Some examples are metadata, participant data, content processing, indexing, snapshot construction & indexing, and tagging. In one aspect, a document format may be identified and parsed into one or more predefined document fields. In another aspect, one or more document sections may be encoded or decoded. In step 620, each document may have its data or metadata enriched as discussed above to facilitate processing with the data domains.

In step 625, identity management is performed. One or more tasks may be performed to determine information about entities or users associated with or referenced by a document. Such information may include information that authenticates the identity of a user or information that describes information and actions a user is authorized to access and/or perform. Descriptive information about a user may be collected and extracted across a variety of documents. In some embodiments, a digital identity for users or entities is generated and may be augmented by external sources, such as corporate directories or other user information repositories.

In step 630, metadata is generated for each document. The metadata provides information about each document, and may include metadata already provided with or in a document. In step 640, content is extracted from each document. In step 645, the extracted content is indexed.

In step 650, snapshot construction is performed. A snapshot as used herein generally refers to a logical storage structure. The structure allows for the reconstruction of a timeline based on a set of communication transcripts correlated by one or more events. In various embodiments, one or more snapshots are created while users are generating communication events. Heuristics, algorithms, or other monitoring mechanisms can be used to detect event changes that result in construction of a snapshot. In some embodiments, a corresponding significant snapshot operation is continually processed for new changes; particularly for related data that has been modified during construction of prior snapshots. In one aspect, each introduction of a new event results in a newly created snapshot. This can be performed as an updated snapshot or as a complete new document structure. In certain embodiments, a snapshot is constructed in response to determining which items of data are related. This can identifying event notifications associated with an item. In step 655, each snapshot is indexed.

In step 660, one or more specialized tagging processes can be performed that allow external application processes (e.g., retention management, disposition, eDiscovery, supervision, doc reviews, etc.) to take fuller advantage of the information contained in each snapshot in a form usable by the applications.

### Result Set Manipulation

As noted earlier, the capture and processing of ESI can result in a large number of data types that may be stored in any number of locations. This may include the capture and processing from email systems, social media data stores in the cloud or stored locally, collaboration systems like SharePoint®, real-time communication systems like Sametime, repositories of structured and unstructured data, employees' home computers, corporate and employee-owned smartphones, tablet computers (e.g., Apple iPad, Dell Streak, etc.), corporate wikis and blogs, desktop computers, laptop computers, file servers, and USB storage devices (e.g., flash memory sticks, iPods, etc.). While email is often the most important single source of content in most organizations, there are many other content types—and locations in which it might be stored—that organizations must include among their discoverable content sources.

The following embodiments are helpful in understanding how various aspects of ESI system 100 interact to provide an information storage and retrieval system that allows enterprises to manage, enforce, monitor, moderate, and review business records associated with a variety of communication modalities. As meaningful statistics, interaction contexts, and other characteristics of the data are indexed and archived, a reviewer can obtain and visualize interactions, conversations, threads, and posts. However, scanning an document corpus can be very costly. Embodiments leverage underlying search technology of ESI system 100 to obtain records by determine the right components that should be searched. Embodiments further implement result set management that allows users to work with fixed data sets that are larger than what can fit in memory of a typical workstation. Embodiments provide in-memory management that is responsive and dynamic allowing a reviewer to change search parameters while reusing any existing data staged as a result of prior searches.

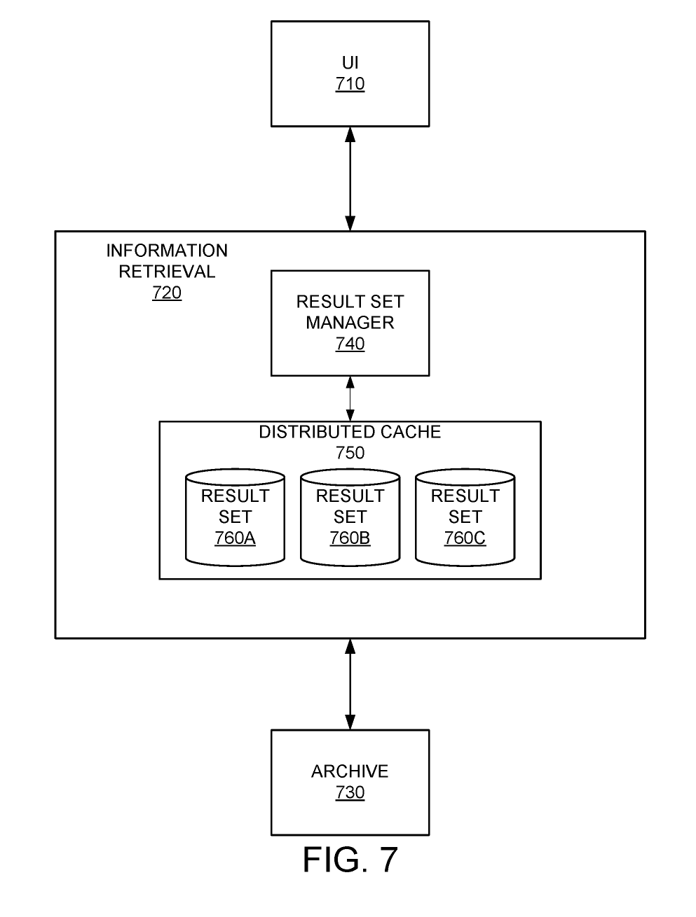

FIG. 7 is a block diagram of a system for managing result sets in certain embodiments according to the present invention. FIG. 7 and other figures are illustrative of embodiments or implementations disclosed herein and should not limit the scope of any claim. One of ordinary skill in the art may recognize through this disclosure and the teachings presented herein other variations, modifications, and/or alternatives to those embodiments or implementations illustrated in the figures. The components can include hardware and/or software elements.

In this example, the system includes user interface component 710, information retrieval component 720, and archive 730. User interface component 710, information retrieval component 720, and archive 730 are each capable of exchanging information, e.g., by communicating with and through the Internet, wide area networks (WANs), metropolitan area networks (MANs), local area networks (LANs), wireless area networks (WiLANs), radio access network (RANs), public switched telephone network (PTSN), etc., and/or combinations of the same). User interface component 710, information retrieval component 720, and archive 730 are each capable of directly exchanging information.

User interface component 710 can provide a reviewer with one or more user interfaces for searching and retrieving information stored by ESI system 100. User interface component 710 can be implemented using a single computer system or may include multiple computer systems, web servers, application servers, networks, interconnects, or the like. User interface component 710 can provide visualizations that include technologies and services such as graphical user interfaces (GUI) that accept input via devices such as a computer keyboard and mouse and provide graphical output on the computer monitor, web-based user interfaces or web user interfaces (WUI) that accept input and provide output by generating web pages which are transmitted via a network and viewed by the user using a web browser program utilizing Java, JavaScript, AJAX, Apache Flex, .NET Framework, or similar technologies, touchscreens, command line interfaces, gesture interfaces which accept input in a form of hand gestures, or mouse gestures sketched with a computer mouse or a stylus, voice user interfaces, which accept input and provide output by generating voice prompts, or the like.

Information retrieval component 720 can interact with various elements of archive 730 in order to present search results to user interface component 710. Information retrieval component 720 can be implemented using a single computer system or may include multiple computer systems, web servers, application servers, networks, interconnects, or the like.

Information retrieval component 720 can interface with the one or more segregated data domains into which each document is deconstructed. For example, information retrieval component 720 can interface with a document index, a metadata index, participant data index, content processing, tagging, etc. Information retrieval component 720 can receive queries from reviewers using user interface component 710 and normalize parameters of the query for interfacing with components of archive 730 that manage the one or more segregated data domains. A multi-variant index can derive a single and normalized searchable content from the viewpoint of the application. Information retrieval component 720 can determine the multi-variables (dimensions) that generated a composite index.

In this example, information retrieval component 720 includes result set manager 740 and distributed cache 750. In embodiments where a multi-variant index is virtualized across segments (shards) on distributed nodes or server farms, information retrieval component 720 can coordinate where data sets are staged. Information retrieval component 720 can stage data sets in memory on distributed nodes or in server farms. In certain embodiments, information retrieval component 720 stages results from various cross-indexes using distributed cache 750, e.g., in result set 760A, result set 760B, and result set 760C.

In various embodiments, results management can be implemented as a software foundation embodied as information retrieval component 720 built into unified context-aware content archive 112 of FIG. 1 allowing comprehensive search-within-search and comprehensive search-within-context. These capabilities solve one or more specialized problems around discovery business workflows. Further, the efficient use of “hold” semantics in legal disposition is afforded by ensuring consistent and coherent capture of data representing a snapshot in time. This allows for deep and iterative search processes that are critical in document filtering, and refinements for selective document-targets within corpuses scoped by the search context.

Search-within-Search as used herein refers to executing native (intrinsic) searches within a repository or information retrieval system that has native built-in search facility. Some examples of information retrieval systems that have native search facilities are relational databases. Typically, an application connects to the information retrieval system via a standardized query facility (JDBC or ODBC), and executes an ANSI-SQL request that the underlying system can execute. Such information retrieval systems typical include components such as (1) query translator, (2) query branch-control flow paths (3) query optimization engines, (4) query execution engine, and (5) results processors using data segments & cursors, paginated records, or full scan data coupled with a high performant indexers.

In certain embodiments, information retrieval component 720 can implement “search-within-search” to use native (domain specific language) features that are offered by other information retrieval system or databases. This opens the full power of the search capabilities to information retrieval component 720 provided by the underlying vendor. Accordingly, information retrieval component 720 ensures native search capabilities (for example, different vendors support different versions and levels of SQL capabilities), specific language characteristics, performance & optimization facilities, storage optimization strategies, and acts as a primary proxy to native search capabilities thus serving as a gateway to the data source. Information retrieval component 720 can take full advantage of storage, and performance characteristics of the underlying system, e.g., full table/repos scans, faceted searches, or paginated data (results).

Search-within-Results as used herein refers to executing search requests against a perceived data source. In one particular case, the data source is the result sets being operated on, acting as a layer of indirection to the native search capabilities through information retrieval component 720. This has one or more advantages over traditional search-with-search methodologies, for example, by providing iterative searches. An iterative search allows an application to effectively “play” with a data set by applying what-if scenarios, prune or expand search context, etc. This can be referred to as exploratory (discovery) searches.

As an iterative search operates on a perceived data source, the data source typically is staged in order for iterations to be processed. This allows a reviewer to work with the entire data set. In various embodiments, information retrieval component 720 dramatically increases performance speeds of staged results, often>100×, using distributed cache 750. In one aspect, distributed cache 750 includes an in-memory cache of staged results. Distributed cache 750 can include portions a data set (or facets) distributed among various nodes or servers.

Information retrieval component 720 can then implement search within the facets in distributed cache 750. Facets as used herein are defined as “dimensions” on a dataset (e.g., cube) that allow sub grouping, sub-categorization for the purposes of drill-through or drill down scenarios. In another aspect, information retrieval component 720 can implement data filtering allowing attributes for data operations such as sorting and group-by requests. These attributes can then be associated with the data set (as a results set) and stored in distributed cache 750. In further embodiments, information retrieval component 720 can implement data faceting where attributes are tagged against the data set to allow search-within-results. Accordingly, distributed cache 750 can include both the data set and a context for searching within the data set which includes attributes defining data operations, faceting, tagging, and the like. Distributed cache 750 can include multiple versions of a data set that each have different attributes.

In various embodiments, information retrieval component 720 can implement search within these multiple data sets using policies (e.g., retention, expiry, level-2 caching). Search within data sets can also be implemented using modification rules (holds, sort criteria, filtering, faceting, etc.). In one aspect, search within data sets can be implemented using derivative index. Each changed set can result in a new index (position). Positions may be referenced by the search context to perform additional searches, or alter data characteristics.

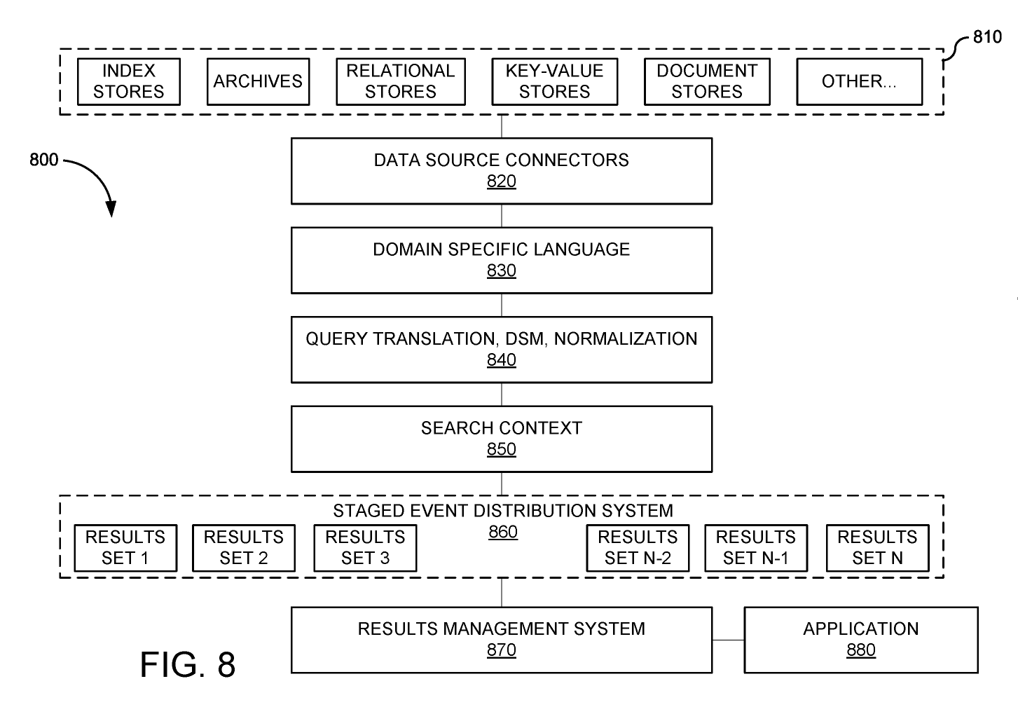

FIG. 8 is a block diagram of architectural elements 800 of a results management system in according with certain embodiments of the present invention. Architectural elements 800 may merely be illustrative of an embodiment or implementation of an invention disclosed herein should not limit the scope of any invention as recited in the claims. One of ordinary skill in the art may recognize through this disclosure and the teachings presented herein other variations, modifications, and/or alternatives to those embodiments or implementations illustrated in the figures.

In this example, architectural elements 800 includes one or more data sources/information retrieval systems 810 (e.g., Index Store, Archive, Relational Stores, Key-Values Stores, Document Stores, Others), one or more data source connectors 820, domain specific language 830, query translation, domain specific modeling, and normalization layer 840, search context 850, staged event distribution system 860 with one or more results sets (e.g., results set 1 . . . result set N), results set management system 870, and application 880.

In a data-source connectors layer, data source connectors 820 allows data to be modeled and incorporate a polyglot persistence architecture. This means that the domain specific models of the underlying repositories can be relatively ignored at all other layers of the architecture. In particular, data source connectors 820 provides full scale in terms of data model paradigms and storage layers from traditional forms of storage, big data or super scale data sources. Examples include Flat-file system, Relation system (Oracle, Microsoft, MySQL, etc), Key-Value databases (typically Big-Data databases), Document databases (XML, JSON specialized document storage system), File Systems (local & distributed like NFS, RDFS, etc.), Archive system (eVault, Actiance, IBM), Email vs Context store, or the like.

Once data source connectors 820 bind to the underlying data stores, domain specific language 830 can be applied. Domain specific language 830 is the language that defined for processing any query exposed to application 880. This is further the interfacing language to the end user. This enables and allows for search and storage agnostic integration to each underlying service. Domain specific language 830 essentially normalizes any SQL dialects into a form that can be processed by results management system 870. Part of this process involves query translation, query de-construction and optimization in layer 840. Once the DSL is decoding, it is translated into a universal model defined by the DSL. This is annotated and normalized into a coherent data—state that is passed from stages of the results processing.

Once a search request is received from application 880 by results management system 870, the search request can be synthesized and then executed on one or more data sources for initial results processing. Search context 850 then is built up and organized into a domain specific model that is passed or handled along the stages of results processing. Search context 860 is parameterized, indexed, cached and passed along with every instance of the result set in staged event distribution system 860.

In certain embodiments, search context 850 includes meta information that describes the full search context containing a DSL-specific query, query parameters, a context-ID and transaction id, metadata scope, filter Scope, facet Scope, execution context information (data source binding, ACL, fetch optimization & strategy plan, etc.), policy definition information (retention, expiry, visibility), or the like.

Each search request results in a new result sets in staged event distribution system 860 that is managed by result management system 870 in accordance to a policy that is established. Each execution is instantiated into a single result-set definition. A policy can describe the retention period (no more than 30 days), expiry date (time when data set expires), faceting policies, and visibility policies via ACL (access control layer definitions).

A result set is a named collection of tuples defined by the query context. It is identified by a unique transaction ID and is managed by the lifecycle as set forth by the associated policy. Each mutation operation (edit, deletion, update, filter (sort-by), facet (group-by) results in a “derived” result-set with a new transaction ID and a carbon-copy search context+altered data set.

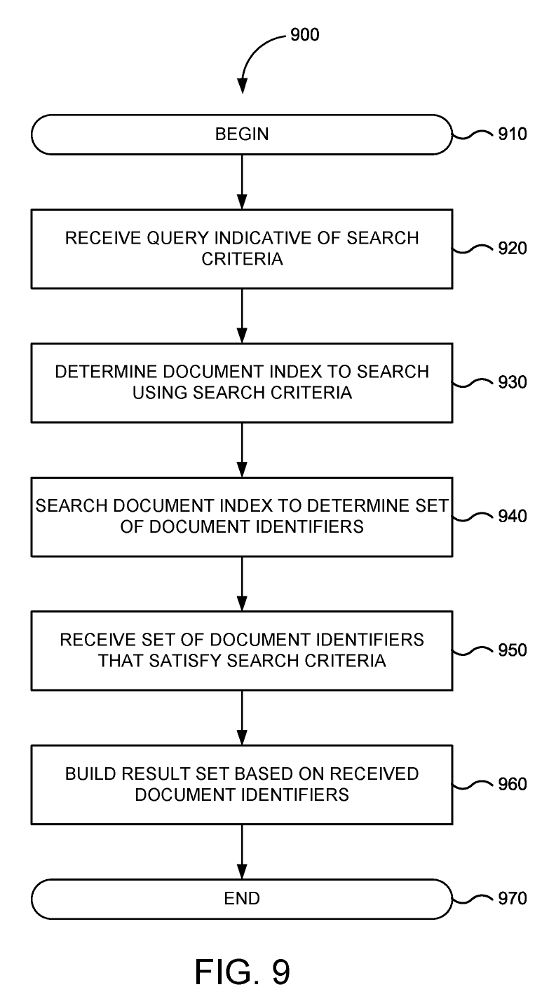

FIG. 9 is a flowchart of method 900 for building result sets in certain embodiments according to the present invention. Implementations of or processing in method 900 depicted in FIG. 9 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 900 depicted in FIG. 9 begins in step 910.

In step 920, a query is received indicative of one or more search criteria. The query can be generated by a user interface component based on input received from a reviewer. The query can further be specified by a review using one or more search syntaxes. The search criteria can be indicative of one or more parameters (dimensions) applicable to one or more indexes of archive 730. Some examples of dimensions include topics, subjects, keywords, sender, recipient, communication modality, or the like.

In step 930, a document index to search is determined using the search criteria. For example, result set manager 740 can determine that a search is required using a keyword index, a topic index, a communication participant index, a communication modality index, or the like. In step 940, the document index is searched to determine a set of document identifiers.

In step 950, the set of documents identified is received. In certain embodiments, retrieval of document identifiers from an index occurs in a paginated manner. In another embodiment, delivery of search results can be delayed until the search is finished.

In step 960, a result set for the query is built based on the document identifiers. Building a result set can involve loading the content for each document identified in the set of document identifiers. Result set manager 740 can determine metadata based on the loaded content or from other searched indexes and use the metadata to build hierarchical relationships between the documents. Documents can be grouped, aggregated, sorted, filtered, etc., in order to build the result set. In certain embodiments, documents can be grouped by thread or by one or more attributes, such as sender, recipient, subject, topic, etc. Documents can be organized into pages that facilitate retrieval and visualization of subsets of the documents.

In certain embodiments, the result set can be formed by one or more sub-datasets. Each sub-dataset can include documents that satisfy the query that are organized in their relationships according to one or more dimensions. These sub-datasets can be distributed across various shards in order to improve information retrieval. Moreover, changes made to the query or other parameters by the review can cause all further processing to be performed with respect to the existing sub-datasets. Thus a reviewer can manipulate a query without incurring the overhead of a new search of archive 730 and construction of a new result set. FIG. 9 ends in step 970.

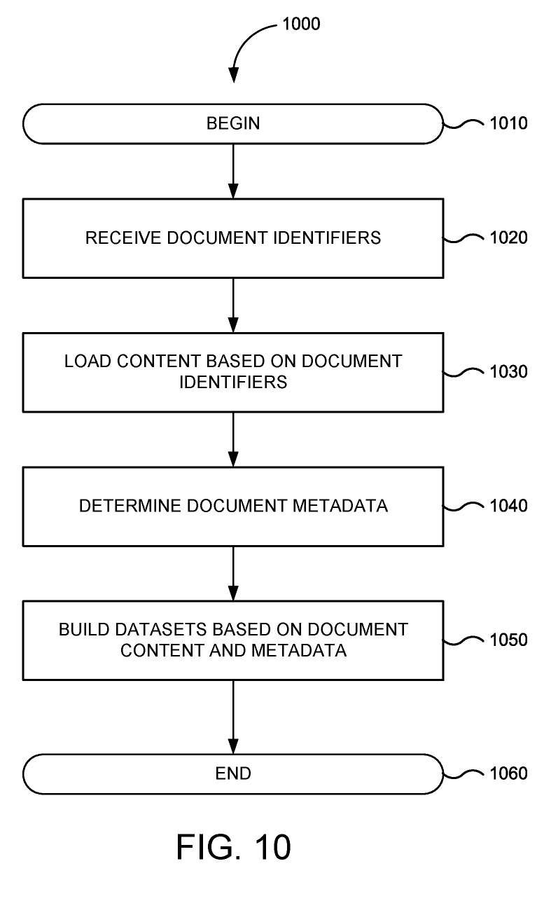

FIG. 10 is a flowchart of method 1000 for building result sets in certain embodiments according to the present invention. Implementations of or processing in method 1000 depicted in FIG. 10 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 1000 depicted in FIG. 10 begins in step 1010.

In step 1020, one or more document identifiers are received. As discussed above, the search criteria can be indicative of one or more parameters (dimensions) applicable to one or more indexes of archive 730. Each document can be indexed according to topics, subjects, keywords, sender, recipient, communication modality, or the like.

In step 1030, content is loaded based on the document identifiers. In step 1040, document metadata is determined. In certain embodiments, the document metadata can be determined from the loaded content. In certain embodiments, the document metadata can be loaded from one or more indices using the document identifiers.

In step 1050, one or more datasets are built based on the document content and metadata. In certain embodiments, one or more relationships are determined between documents using the document metadata. Relationships can be based on sender, recipient, topic, communication modality, etc. These datasets can be distributed across various shards in order to improve information retrieval. Moreover, changes made to the query or other parameters by the review can cause all further processing to be performed with respect to the existing sub-datasets. Thus a reviewer can manipulate a query without incurring the overhead of a new search of archive 730 and construction of a new result set.

### Visualization

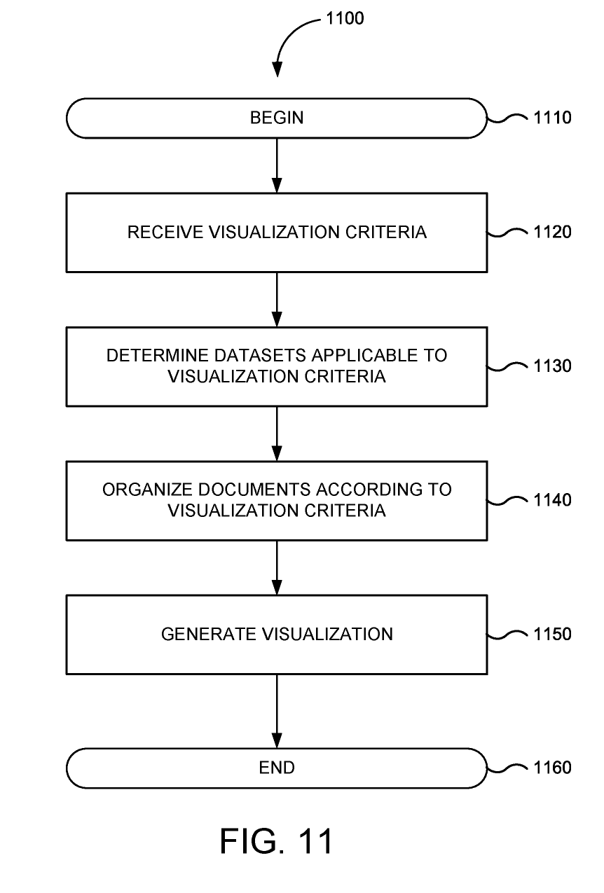

FIG. 11 is a flowchart of method 1100 for generating one or more visualizations using result sets in certain embodiments according to the present invention. Implementations of or processing in method 1100 depicted in FIG. 11 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 1100 depicted in FIG. 11 begins in step 1110.

In step 1120, one or more visualization criteria are received. The visualization criteria can be indicative of one or more parameters (dimensions) applicable to documents in the result set. Visualization criteria may sort, group, aggregate, filter, or otherwise indicate how to visualize one or more documents on the result set.

In step 1130, one or more datasets are determined that are applicable to the visualization criteria. The visualization criteria can be applicable to all or some of the datasets. In step 1140, once applicable datasets are determined, the documents are organized according to the visualization criteria.

In step 1150, one or more visualizations are generated from the organized documents. In certain embodiments, a visualization includes a time-based view of one or more threads. In certain embodiments, a communication graph can be generated and displayed that produce: a timeline view of the communication, a graph of the communication paths between the participants and aggregation type reports displayed as charts or graphs, or the like. In some embodiments, a visualization can include an inbox-style display. Documents can be organized visually into threads based on their relationships with each other. The inbox-style display can allow a reviewer to view results of a query immediately. As documents are included in the result set, grouped, aggregated, sorted, or filtered, the display can be dynamically updated to reflect the relationships between the documents in the result set.

### Example Embodiments

The following examples provide non-limiting illustrations of typical use cases for generating a result set and visualization that corresponds to the particular needs of a user. Typically, the user query is received from a client device (e.g., mobile phone, tablet, wearable, laptop, desktop, workstation, etc.) and includes both search criteria (e.g., key words to match particular filters) and, in some cases, a projection. A projection may indicate how the results should be returned. Some non-limiting examples include displaying/sorting by relevance, subject, timestamp, number of items returned per page, channel, network, grouping of participants, by/to/from/cc'd senders and recipients, and the like. For example, to implement a timeline view of interactions, the projection data may include network and channel data, date, thread ID (to relate participants), and the like, to see when certain types of communications occurred. For a communication graph, the projection data may indicate that the result set be grouped by participants in a communication to see who certain participants are interacting with and how often.

In some cases, staging for the filtered set of documents from the document corpus may be stored in a different location than corresponding metadata. As discussed above, it should be noted that “documents” may refer to IMs, wiki entries, tweets, blog posts, etc., and is meant to be used as an all-encompassing term for any form of stored digital communication. Typically, the list of corresponding documents are indexed as a result set that does not include a robust set of corresponding metadata (e.g., in some cases limited to a timestamp). A more complete set of metadata for the indexed result set are typically stored in a separate database, as further described above. Thus, some embodiments may employ three separate databases including the document corpus, the indexed set of documents (i.e., result set) resulting from the corresponding search inquiry, and a metadata database corresponding to the indexed documents. Other data organizational arrangements may be employed (e.g., using fewer or more separate databases), as would be appreciated by one of ordinary skill in the art with the benefit of this disclosure.

In some embodiments (as described above), a search may include finding a complete result set before generating a corresponding visualization. In certain scenarios where a particularly large document corpus is accessed, a result set may contain thousands or even millions of search results. There may be some processing delay associated with the search as each document in the search result set has to be processed and organized according to the projection indicated by the user. Delay may be further exacerbated in systems with limited processing resources (e.g., limitations in processing power, parallel processing, etc.). Accordingly, certain projections that call for a complete result set (e.g., social graph or communication channel) before generating a corresponding visualization may be subject to processing delays that may several minutes to complete depending on the complexity of the search and requested projection and the available processing resources.

However, some embodiments may use a modified search/display scheme to increase the speed of result set processing. This can be particularly useful for searches that do not require a full result set to be presented to a user. One example can include performing a single call to a document index (from a result set) to quickly display one page at a time, despite the fact that the result set and corresponding visualization may still be processing in the background. In the example above where the result set may be very large (e.g., ˜1 M), returning a search result (e.g., based on relevancy) one page at a time may result in <1 s completion time, even in systems with limiting processing resources. In some implementations, the returned list may be modified as new results are found, and other visualizations (e.g., timeline, communication/social graphs, etc.) corresponding to the requested projection that may require processing the full result set can be processed in the background and presented to the user when completed.

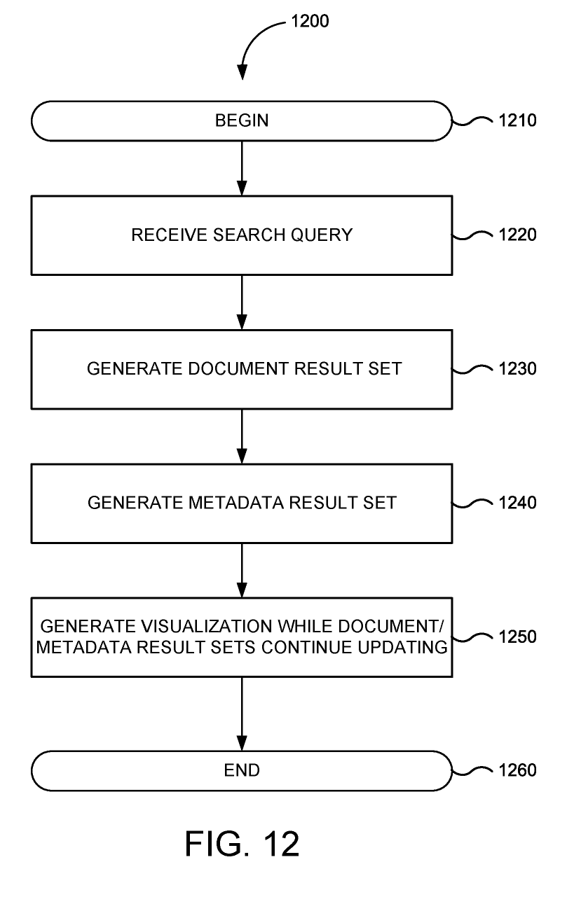

FIG. 12 is a flowchart of method 1200 for generating one or more visualizations using result sets, according to certain embodiments. Implementations of or processing in method 1200 depicted in FIG. 12 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 1200 depicted in FIG. 12 begins in step 1210.

At step 1220, method 1200 can include receiving a search query including one or more search criteria and generating/staging a document result set that includes a list of matching documents that correspond to the search criteria (step 1230). In some cases, the document result set may include a list of documents (e.g., document IDs).

At step 1240, method 1200 can include retrieving metadata for the documents included in the result set. Typically, the document IDs do not contain a robust set of associated metadata, such that metadata made available via the document result set may be limited to timestamps, creation dates, or the like. Thus, aspects of the invention access the corresponding metadata for each document ID (from the document database to access the documents themselves) to retrieve additional metadata to be used in the resulting visualization (e.g., as typically indicated by or in conjunction with the search query as projection data).

By way of example, a search query and request for a communication graph (e.g., displaying participants in a communication) may result with over 1 M matching documents. The IDs and limited metadata (e.g., timestamp, date) can be retrieved and staged (i.e., staging document result set) in one or more temporary data structures. The limited metadata typically does not include additional information like participants in the (document) communication, communication modalities (e.g., IM, SMS texting, Skype, etc.). Thus, the actual matching documents can be accessed to retrieve the additional metadata to enrich the metadata staged in memory. Once the document and metadata result sets are complete, a visualization (using the additional metadata) can then be processed. However, this process may be subject to delays as some documents may be distributed throughout multiple computers, networks, etc., as described above. In some implementations, while data is still being sorted into their corresponding data structures (e.g., document IDs added to the document result set and metadata added to the metadata result set as the search progresses), certain visualizations of data can be presented to a user even through the result set and metadata enrichment process may be incomplete (step 1250). One example may include a paginated result of “most relevant,” “creation date,” or the like, as would be appreciated by one of ordinary skill in the art with the benefit of this disclosure. Method 1200 ends at step 1260.

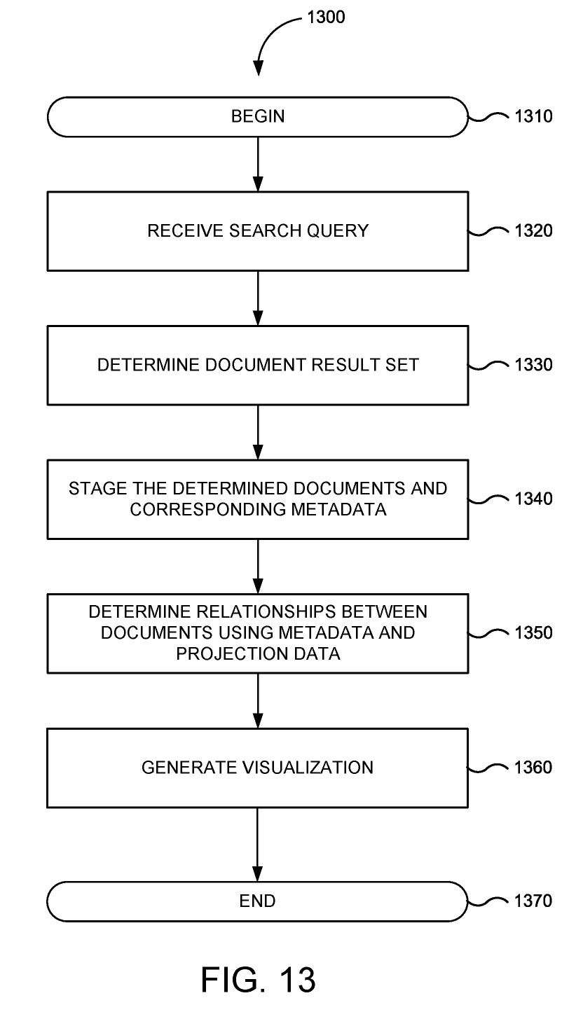

FIG. 13 is a flowchart of method 1300 for staging search results from a document corpus, according to certain embodiments. Implementations of or processing in method 1300 depicted in FIG. 13 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 1300 depicted in FIG. 13 begins in step 1310.

At step 1320, method 1300 may include receiving, at one or more computer systems, a query including one or more search criteria for searching a document corpus and projection data indicating how to organize a corresponding resulting search.

At step 1330, method 1300 may include determining, with one or more processors associated with the one or more computer systems, a set of documents stored in one or more document archives of the document corpus that includes data corresponding to the one or more search criteria.

At step 1340, method 1300 may include staging, with the one or more processors associated with the one or more computer systems, each document in the set of documents in a first result set (e.g., document index) and metadata associated with the one or more documents in the set of documents in a second result set. The first and second result sets may be separate temporary data structures. In some case, individual result sets can be stored as multiple linked temporary data structures. Alternatively, the document result set and corresponding metadata may be housed in a single data structure, as would be appreciated by one of ordinary skill in the art with the benefit of this disclosure.

At step 1350, method 1300 may include determining, with the one or more processors associated with the one or more computer systems, a set of relationships between the one or more documents using the metadata and the projection data.

At step 1360, method 1300 may include organizing, with the one or more processors associated with the one or more computer systems, the result set into a visualization using the determined set of relationships. Method 1300 ends at step 1370.

### Example Hardware

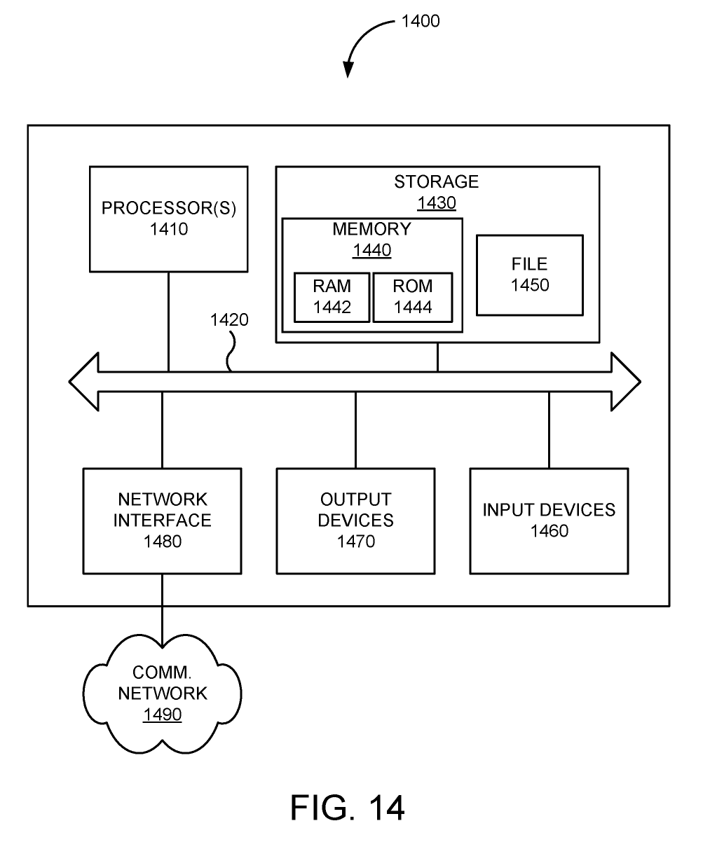

FIG. 14 is a block diagram of a computer system 1400 in an exemplary implementation of the invention. In this example, the computer system 1400 includes a monitor 1410, computer 1420, a keyboard 1430, a user input device 1440, one or more computer interfaces 1450, and the like. In the present embodiment, the user input device 1440 is typically embodied as a computer mouse, a trackball, a track pad, a joystick, wireless remote, drawing tablet, voice command system, eye tracking system, and the like. The user input device 1440 typically allows a user to select objects, icons, text and the like that appear on the monitor 1410 via a command such as a click of a button or the like.

Embodiments of the computer interfaces 1450 typically include an Ethernet card, a modem (telephone, satellite, cable, ISDN), (asynchronous) digital subscriber line (DSL) unit, FireWire interface, USB interface, and the like. For example, the computer interfaces 1450 may be coupled to a computer network 1455, to a FireWire bus, or the like. In other embodiments, the computer interfaces 1450 may be physically integrated on the motherboard of the computer 1420, may be a software program, such as soft DSL, or the like.

In various embodiments, the computer 1420 typically includes familiar computer components such as a processor 1460, and memory storage devices, such as a random access memory (RAM) 1470, disk drives 1480, and system bus 1490 interconnecting the above components.

The RAM 1470 and disk drive 1480 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like.

In various embodiments, the computer system 1400 may also include software that enables communications over a network such as the HTTP, TCP/IP, RTP/RTSP protocols, and the like. In alternative embodiments of the present invention, other communications software and transfer protocols may also be used, for example IPX, UDP or the like.

It may be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other micro processors are contemplated, such as Pentium™ or Core™ microprocessors from Intel; Sempron™ or Athlon64™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board (e.g. a programmable logic device or a graphics processor unit).

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A computer-implemented method comprising:
receiving, at one or more computer systems, a query including:
one or more search criteria for searching a document corpus; and
projection data indicating how to organize a corresponding resulting search;
determining, with one or more processors associated with the one or more computer systems, a set of documents stored in one or more document archives of the document corpus that includes data corresponding to the one or more search criteria;
staging, with the one or more processors associated with the one or more computer systems, each document in the set of documents in a result set;
staging, with the one or more processors associated with the one or more computer systems, metadata associated with one or more documents in the set of documents in the result set;
determining, with the one or more processors associated with the one or more computer systems, a set of relationships between the one or more documents using the metadata and the projection data; and
organizing, with the one or more processors associated with the one or more computer systems, the result set into a visualization using the determined set of relationships.

2. The method of claim 1 wherein the result set is distributed across a plurality of memory devices associated with the one or more computer systems, and the method further includes:
staging content retrieved from the one or more document archives for the one or more documents using a distributed cache.

3. The method of claim 1 further comprising:
augmenting content in the result set using information retrieved from one or more data sources external to the document archive based on the metadata.

4. The method of claim 1 further comprising:
receiving, at the one or more computer systems, a policy; and
managing, with the one or more processors associated with the one or more computer systems, a lifecycle of the result set in the plurality of memory devices associated with the one or more computer systems using the policy.

5. The method of claim 1 wherein determining, with the one or more processors associated with the one or more computer systems, the set of relationships between the one or more documents using the metadata includes generating relationships between the one or more documents using a sender identifier or one or more recipient identifiers.

6. The method of claim 1 wherein determining, with the one or more processors associated with the one or more computer systems, the set of relationships between the one or more documents using the metadata includes generating relationships between the one or more documents using a subject or a topic.

7. The method of claim 1 wherein determining, with the one or more processors associated with the one or more computer systems, the set of relationships between the one or more documents using the metadata includes generating relationships between the one or more documents using a communication modality.

8. The method of claim 1 wherein determining, with the one or more processors associated with the one or more computer systems, the set of relationships between the one or more documents using the metadata includes filtering out documents from the set of documents that have no relationship to the one or more documents.

9. The method of claim 1 wherein organizing, with the one or more processors associated with the one or more computer systems, the result set into a visualization using the determined set of relationship includes sorting documents in the result set using a sender identifier or a recipient identifier.

10. The method of claim 1 wherein organizing, with the one or more processors associated with the one or more computer systems, the result set into a visualization using the determined set of relationship includes organizing documents in the result set using a subject, a topic, or a communication modality.

11. A non-transitory computer-readable medium storing program code executable by a processor of a computer system, the non-transitory computer-readable medium comprising:
program code that causes the processor to receive a query including:
one or more search criteria; and
projection data indicating how to organize a corresponding resulting search;
program code that causes the processor to determine a set of documents stored in one or more document archives of the document corpus that includes data corresponding to the one or more search criteria;
program code that causes the processor to stage each document in the set of documents in a result set;
program code that causes the processor to stage metadata associated with one or more documents in the set of documents in the result set;
program code that causes the processor to determine a set of relationships between the one or more documents using the metadata and the projection data; and
program code that causes the processor to organize the result set into a visualization using the determined set of relationships.

12. The non-transitory computer-readable medium of claim 11 wherein the result set is distributed across a plurality of memory devices associated with the one or more computer systems, and wherein the program code further causes the processor to stage content retrieved from the one or more document archives for the one or more documents using a distributed cache.

13. The non-transitory computer-readable medium of claim 11 further comprising:
program code that causes the processor to augment content in the result set using information retrieved from one or more data sources external to the document archive based on the metadata.

14. The non-transitory computer-readable medium of claim 11 further comprising:
program code that causes the processor to receive a policy; and
program code that causes the processor to manage lifecycle of the result set in the plurality of memory devices associated with the one or more computer systems using the policy.

15. The non-transitory computer-readable medium of claim 11 wherein the program code that causes the processor to determine the set of relationships between the one or more documents using the metadata includes program code that causes the processor to generate relationships between the one or more documents using a sender identifier or one or more recipient identifiers.

16. The non-transitory computer-readable medium of claim 11 wherein the program code that causes the processor to determine the set of relationships between the one or more documents using the metadata includes program code that causes the processor to generate relationships between the one or more documents using a subject or a topic.

17. The non-transitory computer-readable medium of claim 11 wherein the program code that causes the processor to determine the set of relationships between the one or more documents using the metadata includes program code that causes the processor to generate relationships between the one or more documents using a communication modality.

18. The non-transitory computer-readable medium of claim 11 wherein the program code that causes the processor to determine the set of relationships between the one or more documents using the metadata includes program code that causes the processor to filter out documents from the set of documents that have no relationship to the one or more documents.

19. The non-transitory computer-readable medium of claim 11 wherein the program code that causes the processor to organize the result set into a visualization using the determined set of relationship includes program code that causes the processor to sort documents in the result set using a sender identifier or a recipient identifier.

20. The non-transitory computer-readable medium of claim 11 wherein the program code that causes the processor to organize the result set into a visualization using the determined set of relationship includes program code that causes the processor to organize documents in the result set using a subject, a topic, or a communication modality.
